(19) United States
(12) Patent Application Publication
(10) Pub. No.: US 2010/0260538 A1
(43) Pub. Date: Oct. 14, 2010

(54) JOINT AND/OR BEARING ARRANGEMENT

(75) Inventor: Hans-Gerd Brunneke, Georgsmarienhutte (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/741,604

(22) PCT Filed: Nov. 13, 2008
(86) PCT No.: PCT/DE2008/050033

§ 371 Date: May 6, 2010

(30) Foreign Application Priority Data
Nov. 16, 2007 (DE) 10 2007 055 251.5

(51) Int. Cl. F16C 11/06; F16J 15/50

(52) U.S. Cl. 403/134

(57) ABSTRACT

A joint and/or bearing arrangement with a joint pin whose head area can move relative to a receiving shell or housing unit, the joint pin being enclosed over at least part of its length by a surrounding sealing sleeve which, at its end axially remote from the head area is in direct or indirect sealing contact with the joint pin and for this comprises a clamping ring radially on the inside, is designed such that associated with the sealing sleeve in the area of its contact against the joint pin a second ring is positioned radially farther out, at least approximately parallel to the first clamping ring and with an axial extension component, which is connected by a radial connector to the first clamping ring to form a receiving unit of portal-shaped cross-section for an axial end area of the sealing sleeve.

This application is a National Stage completion of PCT/DE2008/050033 filed Nov. 13, 2008, which claims priority from German patent application serial no. 10 2007 055 251.5 filed Nov. 16, 2007.

### FIELD OF THE INVENTION

The invention concerns a joint and/or bearing arrangement and a motor vehicle with one or more such joint and/or bearing arrangement(s), in particular in chassis and/or steering components.

### BACKGROUND OF THE INVENTION

In joint arrangements comprising a movably mounted pin, such that with its widened and ball-shaped head area, the pin is fitted in and can move relative to a receiving joint or bearing shell, the friction contact area between the head and the bearing shell must be protected and sealed as much as possible against the entry of particles and/or moisture and their effects. For this purpose it is known to surround the pin over a large part of its axial length with a sealing sleeve made from a material sufficiently elastic to follow the movements, in particular the tilting movements of the pin. At its end remote from the head area of the pin, this sealing sleeve must therefore be held onto the pin in such a manner that it there forms an effective and durable seal while at the same time allowing the end to follow the movement of the pin.

It is known to hold the axial end of the sealing bellows with a press fit on the joint pin by means of a metallic retaining ring with some axial extension. In this case, however, a further radially inward-directed force must be applied to a seal resting on the outside against the retaining ring, for example by means of a separate clamping ring, in order to secure the seal against the retaining ring. This complicates assembly and increases the number of components required.

### SUMMARY OF THE INVENTION

The purpose of the present invention is to address the problem of achieving an improvement in the case of joints with movable pins and a sealing ring resting in contact on them.

The design according to the invention provides a joint and/or bearing arrangement which, in the contact area of the sealing sleeve with the pin, forms an at least three-sided receiving space for grease or a similar sealing and lubricating mass and which therefore has a long life.

Furthermore, it is not necessary to provide a further, separate clamping ring, but rather, the receiving unit can exert sufficient clamping force to press itself and the sealing rim of the sealing sleeve against the joint pin and hold them in position there. This reduces the number of both components and assembly steps needed.

Particularly advantageously, the receiving unit according to the invention can form an annular body consisting overall of only one element and thus comprising a minimum number of components for securing the sealing rim of the sealing sleeve.

Particularly favorably, the receiving unit with the firmly secured end area of the sealing sleeve and if necessary with a lubricant filling can form a prefabricated assembly which can be fitted onto the joint pin with an axial assembly component, in particular without any further clamping ring being needed for holding the receiving unit. This not only minimizes the number of components but also substantially simplifies assembly.

If the receiving unit as such is rigid and both the inner clamping ring and the outer ring can be held on the pin with pre-stressing, both rings can contribute toward holding the unit onto the pin. In addition the outer ring can secure the gripped sealing rim of the sleeve against slipping off.

In particular the receiving unit then forms, in cross-section, a three-sided, closed and partly lubricant-filled receiving space for the end area of the sealing bellows, so that the outer ring not only has a holding function but also, as a second function, forms a sealing web for the held end area of the sealing bellows. A beading-over or similar flanging of the open U-arm can be provided for particularly wide closing of the receiving space, to provide even better security against pulling out and particularly good sealant and lubricant containment.

Moreover, the rim of the sealing sleeve can form a labyrinth filled with lubricant in the area of its contact against at least one of the U-arms, in order thereby to further improve the permanent seal, especially against the penetration of moisture.

To contact the pin and if necessary a control arm holding it, the inner clamping ring can advantageously be provided on the outside with a sealing surface, as illustrated in the drawings.

A motor vehicle with at least one joint and/or bearing arrangement according to the invention, in particular in chassis and/or steering components exposed to particularly severe risk of becoming dirty, is claimed separately.

### BRIEF DESCRIPTION OF THE DRAWINGS

Further advantageous and features of the invention emerge from example embodiments of the object of the invention illustrated in the drawing and described below.

The drawing shows:

FIG. 1: Schematic overall view of a joint and/or bearing arrangement according to the invention, with a sealing sleeve secured by a clamping ring in the vicinity of the head area, which at the end axially remote therefrom is secured onto the pin by an annular receiving unit according to the invention, the representation in the drawing being shown in section on the left of the longitudinal axis

FIG. 2: View similar to FIG. 1, but with the joint pin deflected

FIG. 3: Enlarged section of the detail III in FIG. 2

FIG. 4: View similar to FIG. 3 of an alternative design of the rim of the sealing sleeve

FIG. 5: View similar to FIG. 4, of a further alternative design of the receiving unit and the rim of the sealing sleeve, with a core ring vulcanized into it

### DETAILED DESCRIPTION OF THE PREFERRED EMBODIMENTS

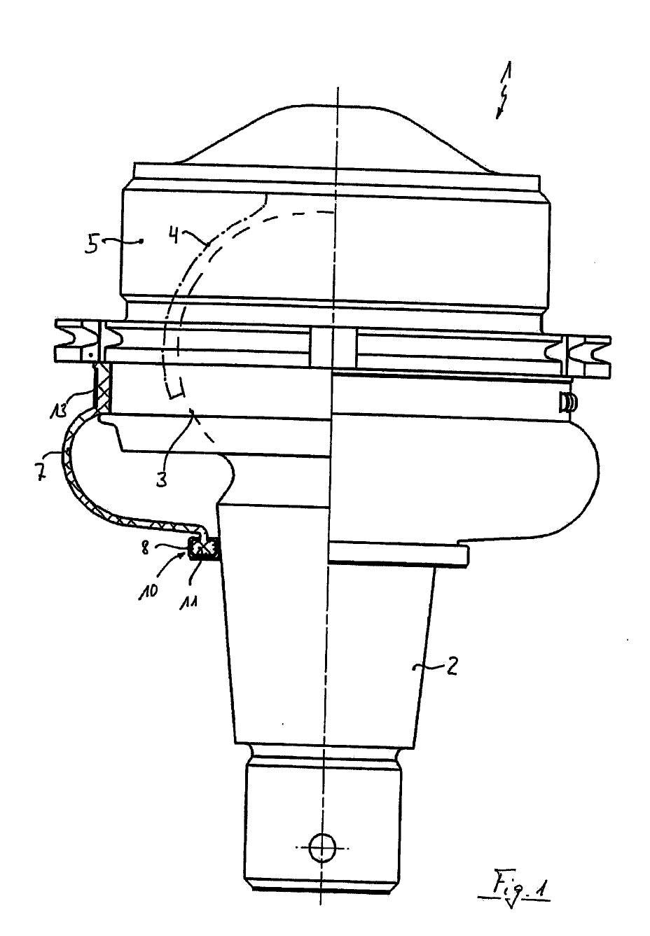

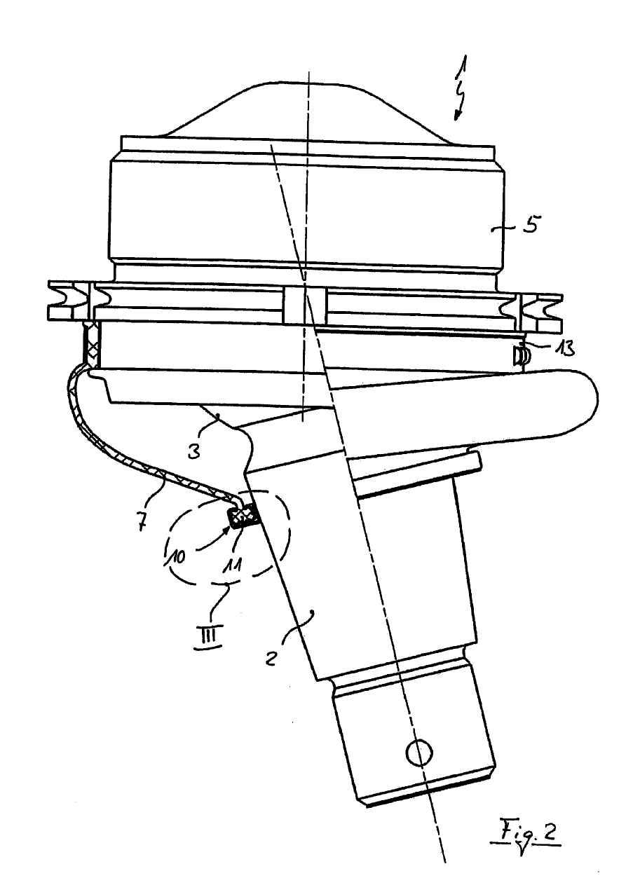

The joint arrangement 1 according to FIG. 1 comprises an axially extending joint pin 2 with a head area 3 which is widened and shaped substantially as a ball, which is indicated by the broken line in FIG. 1. This can be held in and against a permanently lubricated joint shell 4 (represented in FIG. 1 by the dot-dash line) which receives the head area so that it can rotate and/or tilt therein. Outside the point where the pin emerges, the joint shell 4 can be essentially closed, or rather, ring-shaped. Such a deflected tilt movement of the joint pin 2 relative to the joint shell is illustrated in FIG. 2.

Furthermore, for its part the joint shell 4 is partially held, at least radially on the outside, by a housing 5 or similar surrounding space. The joint shell 4 and receiving space 5 as a whole form a mounting unit. The housing 5 does not have to be a separate assembly, but rather, it can be an integral part of a control arm which holds the mounting unit in the assembled condition and is made as a cast or forged component.

The joint and/or bearing arrangement 1 also has a sealing sleeve 7, often in the form of a sealing bellows, which surrounds part of the pin 2. In the area of the emergence opening left in the housing 5 for the pin 2, it is connected to the mounting unit and ensures that in the area of the joint shell 4 and the head 3, particle or moisture penetration is as minimal as possible. For this purpose the sealing bellows 7, at its axial end near the head area 3, is fixed to the housing 5 for example by a clamping ring 13. In contrast, at its end 11 axially remote from this, the sealing bellows 7 is directly or indirectly in sealing contact against the joint pin 2.

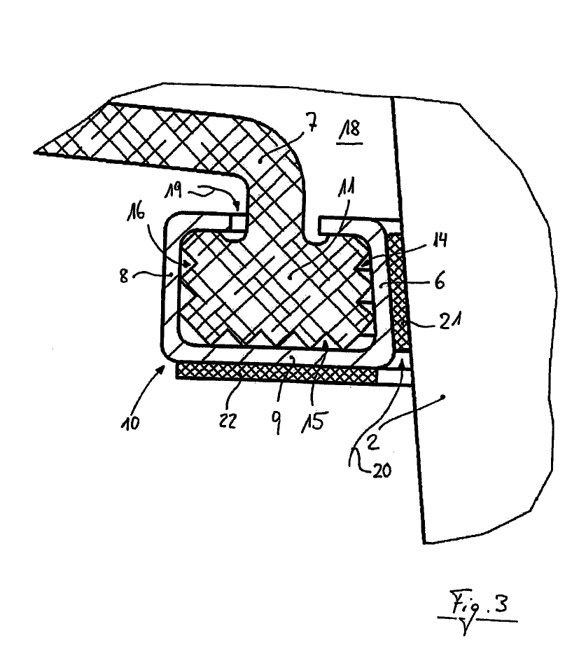

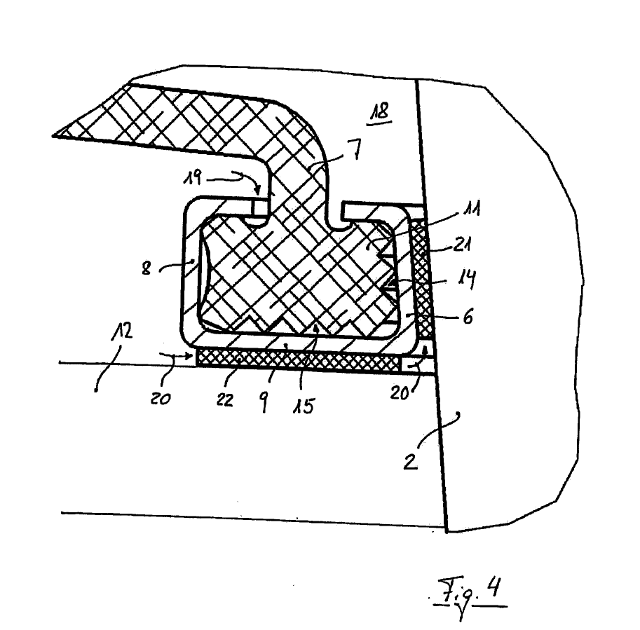

For this unit, according to the invention a receiving unit 10 at least U-shaped in cross-section—i.e. closed on three sides—is provided for the axial end area 11 of the sealing bellows 7. This comprises a radially inner clamping ring 6 and, at least approximately parallel thereto, a second ring 8 positioned radially farther out, both of them with an axial extension component. These two rings 6, 8 are connected by a radial connector extending transversely thereto, to the receiving unit 10 of the U-shaped cross-section for the end area 11. The end area 11 is thickened all round and, in the first example embodiment shown in FIGS. 1 to 3, forms a labyrinth 14, 15, 16 or similar structure respectively radially inside, radially outside and extending axially away from the head area 3. This serves in each case to contain sealing grease or a similar lubricant. Thus, the sealing grease is held respectively between the labyrinths 14, 15, 16 and the inside of the inner ring 6 or of the outer ring 8 or of the radial connector 9. Accordingly, all these form preferably closed areas in order to prevent the escape of the sealant. This results in a particularly thorough sealing of the inside space 18 to be protected by the sealing bellows 7 against any inward migration of the impurities from the direction of the arrow 19 (FIG. 3). To prevent inward migration of the impurities in the direction of the arrow 20, a sealing surface 21 can also be provided between the radially inner ring 6 and the pin 2. Likewise, the radial connector 9 can if necessary be provided with a sealing surface 22 on the outside, where it is in contact with a control arm 12 holding the joint pin 2 (as shown in FIG. 4).

For high stability and at the same simple production, the receiving unit 10 as a whole can form an integral double-ring element comprising the two rings 6, 8. The receiving unit 10 is then rigid as such, so that both the inner ring can be held with pre-stress, and also the outer ring 8 can be pre-stressed onto the pin 2.

In this case not only does the outer ring 8 secure the receiving unit 10 and the end area 11 of the sealing sleeve 7 onto the joint pin 2, but with a dual function it at the same time forms a sealing arm for the end area 11, which is here substantially rectangular in cross-section and is held between the elements 6, 8.

Thus, by means of the outer ring 8 on the one hand the sealing sleeve 7 can be secured in one assembly step without the need for a separate component for this. At the same time, by virtue of the additional sealing arm on the inside of the ring 8 the length of the sealing line is extended considerably, which results in significantly better sealing and life.

The receiving unit 10 can be formed of a metallic material, especially rust-resisting stainless steel, or a plastic material, in particular fiber-reinforced. For high stability even over prolonged use, each ring 6, 8 of the receiving unit 10 and the radial connector 9 as well should have sufficient wall thickness, for example 1.5 to 2.5 millimeters.

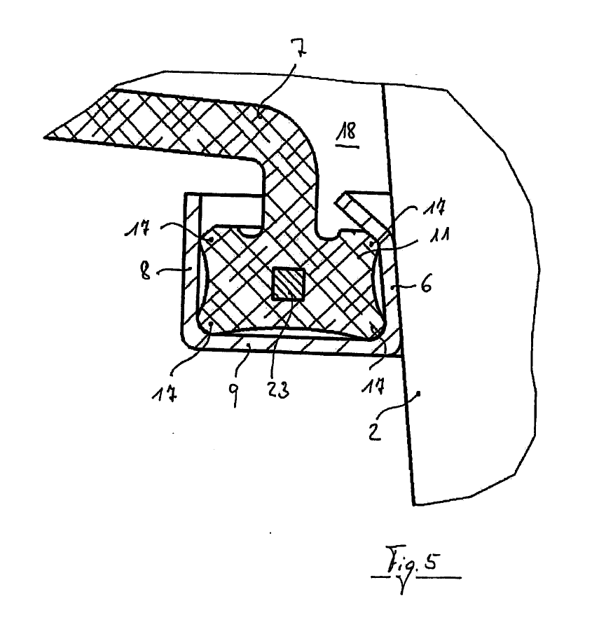

FIG. 4 shows an additional example embodiment in which the labyrinth seal 16 on the outer arm 8 is omitted. In this case the contact against the control arm 12 via the sealing surface 22 is shown, so that here the inward migration of dirt in the direction of the arrow 20 is doubly-blocked by the sealing surfaces 21, 22. In FIG. 5, for different requirements respective particularly large receiving spaces for sealing grease or suchlike are provided. In addition, the shape stability of the end area 11 is ensured by an inset core ring 23. The end area 11 is sealed in the holding ring by force-fitted flanks 17 at its corners.

It is also shown in FIGS. 1 to 4 that once the end area 11 has been inserted, the open ends of the U-arms 6, 8 can be beaded over or deformed inward in a similar manner, so as to ensure particularly good security against pulling out and at the same time to enclose the space for holding grease or a similar sealing and lubricating medium as closely as possible.

Furthermore—otherwise than illustrated—the radial connector 9 can have a different shape, such as rounded or oblique to the radial direction, so that the receiving area 10 is more C-shaped in cross-section. In all cases, however, it is enclosed by an outer and an inner ring surface 8, 6 with the element 9 between them.

A particular advantage of the invention is that the receiving unit 10 with the end area 11 of the sealing sleeve 7 firmly inserted and if necessary with a lubricant filling, can form a prefabricated assembly which can be fitted onto the joint pin 2 with an axial fitting component in a single step, since a separate outer ring for holding the sealing end area 11 onto the inner ring 6 is no longer needed. Even without this separate ring the receiving areas 10 according to the invention can be held on the joint pin 2 with a press fit.

The vulcanization in place of a stabilizing core ring 23 as shown in FIG. 5 does not in any way affect the ability to prefabricate the assembly and fit it in a single assembly step, and the simplification achieved thereby.

Thanks to its good durability properties the invention is particularly well suited for using in areas of motor vehicles severely exposed to dirt, which can comprise such joint and or bearing arrangements particularly also in chassis and/or steering components.

### LIST OF INDEXES

1 Joint or bearing arrangement

2 Pin

3 Head area

4 Joint shell

5 Housing

6 Inner ring

7 Sealing sleeve

8 Outer ring

9 Radial connector

10 Receiving unit

11 Annular end area

12 Control arm

13 Clamping ring

14 Labyrinth seal

15 Labyrinth seal

16 Labyrinth seal

17 Flank

18 Inside space

19 Direction

20 Direction

21 Sealing surface

22 Sealing surface

23 Core ring

1-12. (canceled)

13. A joint and/or bearing arrangement (1) with a joint pin (2) whose head area (3) being movable relative to one of a receiving shell (4) and a housing unit (5), at least part of a length of the joint pin (2) being enclosed by a surrounding sealing sleeve (7) which, at an end axially remote from the head area (3), is one of in direct sealing contact and indirect sealing contact with the joint pin (2) and for this comprises a radially inside clamping ring (6),
wherein a second ring (8), positioned radially farther out from the joint pin (2), is associated with the sealing sleeve (7) in an area of contact with the joint pin (2), the second ring (8) is at least approximately parallel to the first clamping ring (6)with an axial extension component, and
the second ring (8) is connected by a radial connector (9) to the first clamping ring (6) to form a receiving unit (10) of portal-shaped cross-section for an axial end area (11) of the sealing sleeve (7).

14. The joint and/or bearing arrangement (1) according to claim 13, wherein the receiving unit (10) forms an integral annular element.

15. The joint and/or bearing arrangement (1) according to claim 13, wherein the receiving unit (10) is rigid and both the inner clamping ring (6) and the outer ring (8) are fitted onto the pin (2) with pre-stress.

16. The joint and/or bearing arrangement (1) according to claim 13, wherein the receiving unit (10) forms a receiving space for the end area (11) of the sealing sleeve (7), and the receiving space, in cross-section, is closed on three sides and is partly filled with a lubricant.

17. The joint and/or bearing arrangement (1) according to claim 13, wherein the outer ring (8) forms a sealing arm for the end area (11) of the sealing sleeve (7) being retained.

18. The joint and/or bearing arrangement (1) according to claim 17, wherein the end area (11) forms a labyrinth that is fillable, in an area of contract against the outer ring, with a lubricant.

19. The joint and/or bearing arrangement (1) according to claim 18, wherein the receiving unit (10) is made from one of a metallic material, a rust-resisting stainless steel, a plastic material and a fiber-reinforced material.

20. The joint and/or bearing arrangement (1) according to claim 19, wherein each of the first and the second clamping rings (6; 8) of the receiving unit (10) and the radial connector (9) have a wall thickness approximately in a range of 1.5 to 2.5 millimeters.

21. The joint and/or bearing arrangement (1) according to claim 13, wherein a sealing surface (21; 22) is provided on an outside of at least one of the inner clamping ring (6) and the radial connector (9) where the inner clamping ring (6) contacts the joint pin (2), and where the radial connector (9) contacts a control arm (12) to retain the joint pin (2).

22. The joint and/or bearing arrangement (1) according to claim 13, wherein the end area (11) of the sealing sleeve (7) is firmly inserted within the receiving unit (10) and, if necessary, with a lubricant filling forms a prefabricated assembly which is fitted onto the joint pin (2) with an axial fitting component.

23. The joint and/or bearing arrangement (1) according to claim 13, wherein the receiving unit is retained, by press fitting, on the joint pin (2) without any additional clamping ring.

24. A motor vehicle in combination with at least one joint and/or bearing arrangement (1) in at least one of a chassis and a steering component, the joint and/or bearing arrangement (1) comprising a joint pin (2) whose head area (3) being movable relative to one of a receiving shell (4) and a housing unit (5), at least part of the length of the joint pin (2) being enclosed by a surrounding sealing sleeve (7) which, at an end axially remote from the head area (3), is one of in direct sealing contact or indirect sealing contact with the joint pin (2) and for this comprises a radially inside clamping ring (6),
wherein a second ring (8), positioned radially farther out from the joint pin (2), is associated with the sealing sleeve (7) in an area of contact with the joint pin (2), the second ring (8) is at least approximately parallel to the first clamping ring (6)with an axial extension component, and
the second ring (8) is connected by a radial connector (9) to the first clamping ring (6) to form a receiving unit (10) of portal-shaped cross-section for an axial end area (11) of the sealing sleeve (7). and associated with the sealing sleeve (7) in an area of contact against the joint pin (2) is a second ring (8) positioned radially farther out, at least approximately parallel to the first clamping ring (6) and with an axial extension component, which is connected by a radial connector (9) to the first clamping ring (6) to form a receiving unit (10) of portal-shaped cross-section for an axial end area (11) of the sealing sleeve (7).
